(19) United States
(12) Patent Application Publication
(10) Pub. No.: US 2010/0287046 A1
(43) Pub. Date: Nov. 11, 2010

(54) CUSTOMER REWARD SYSTEM

(76) Inventors: Nicholas Luke Bennett, Manly Vale (AU); Paul Barnes, Rosebery (AU)

Correspondence Address: MCANDREWS HELD & MALLOY, LTD, 500 WEST MADISON STREET, SUITE 3400, CHICAGO, IL, 60661, US

(21) Appl. No.: 12/777,870

(22) Filed: May 11, 2010

Related U.S. Application Data
(63) Continuation of application No. 11/960,354, filed on Dec. 19, 2007, now abandoned.
Application No. 11/960,354 is a continuation of application No. 10/129,714, filed on May 7, 2002, now abandoned.

(30) Foreign Application Priority Data
Nov. 4, 1999 (AU) PQ3860

(51) Int. Cl. G06Q 30/00

(52) U.S. Cl. 705/14.31; 705/14.27

(57) ABSTRACT

A customer reward system includes at least one activity monitoring device for monitoring trading activity. A processor is associated with the, or each, activity monitoring device for receiving data from said activity monitoring device, for comparing the data with a predetermined trigger condition, the trigger condition being selected from a particular set of conditions, and, when the data and the predetermined trigger condition coincide, generating an output signal indicative of a customer reward.

### RELATED APPLICATIONS

This application claims priority to, and is a continuation of, U.S. application Ser. No. 11/960,354, filed on Dec. 19, 2007, which claims priority to U.S. patent application Ser. No. 10/129,714, filed on Oct. 19, 2000, which claims priority to PCT Application No. PCT/AU00/01270, filed on Oct. 19, 2000, which in turn claims priority to Australian Application No. PQ 3860, filed on Nov. 4, 1999, each of which is herein incorporated by reference in its entirety.

### BACKGROUND OF THE INVENTION

This invention relates to customer loyalty programs. More particularly, the invention relates to a customer reward system.

In today's environment, it is becoming increasingly important to attract new customers and to maintain the loyalty of existing customers. Various strategies are available for maintaining customer loyalty, for example, scratch card-type competitions, promotional games, or the like.

### BRIEF SUMMARY OF THE INVENTION

According to a first aspect of the invention there is provided a customer reward system which includes:

at least one activity monitoring means for monitoring trading activity; and

a processing means associated with the, or each, activity monitoring means for receiving data from said activity monitoring means, for comparing the data with a predetermined trigger condition, the trigger condition being selected from a particular set of conditions, and, when the data and the predetermined trigger condition coincide, generating an output signal indicative of a customer reward.

The trigger condition may be a random number and the particular set of conditions from which the random number is selected is a set of numbers. The numbers of the set may relate to a monetary amount or, instead, the numbers of the set may relate to a quantity of goods vended.

The system may include a display means. The display means may display the trading activity, an initiating condition and the trigger condition.

The initiating condition may be a minimum amount of trading activity which is required before the awarding of the customer reward becomes applicable.

The invention may be applicable over a wide range of trading activities from the sale or hiring out of merchandise or goods to the placing of a bet at a betting agency.

The generation of the customer reward signal may alert an operator of the activity monitoring means and data relating to the winning customer may be displayed on the display means.

It will be appreciated that the activity monitoring means may be a point of sales terminal, such as a cash register, a token issuing device, an EFTPOS device, or the like.

A plurality of activity monitoring means may be connected to the processing means so that activity at any one of the activity monitoring means generates the customer reward signal. In addition, in the case where there is a large number of related venues, for example, in the case of a chain of fast food outlets, the venues or outlets may be networked with one another. In the latter case, trading activity at any one of the networked outlets may cause the customer reward signal to be generated. When this occurs, the customer reward, and the venue or outlet at which it has occurred, may be displayed on the display means at each of the outlets.

According to a second aspect of the invention there is provided a method of rewarding a customer which includes the steps of:

monitoring trading activity; comparing data relating to trading activity with a predetermined trigger condition, the trigger condition being selected from a particular set of trigger conditions; and

rewarding a customer when the data and the trigger condition coincide.

The trigger condition may be a random number and the method may include selecting the random number from a predetermined set of numbers.

The method may include displaying data relating to a rewarded customer on a display means.

The method may also include assigning a number to each activity comparing the assigned number to the selected random number, allocating a customer reward if the assigned number and the selected number coincide and if the assigned number and the selected number do not coincide, comparing an assigned number of each subsequent activity with the selected number until the assigned number and the selected number coincide. The assigned number may relate to a monetary amount. Instead, the assigned number may relate to a quantity of goods vended.

### BRIEF DESCRIPTION OF SEVERAL VIEWS OF THE DRAWINGS

The invention is now described, by way of example, with reference to the accompanying drawings in which

FIG. 1 shows a block diagram of a customer reward system, in accordance with the invention; and

FIG. 2 shows a flowchart of the operation of the customer reward system.

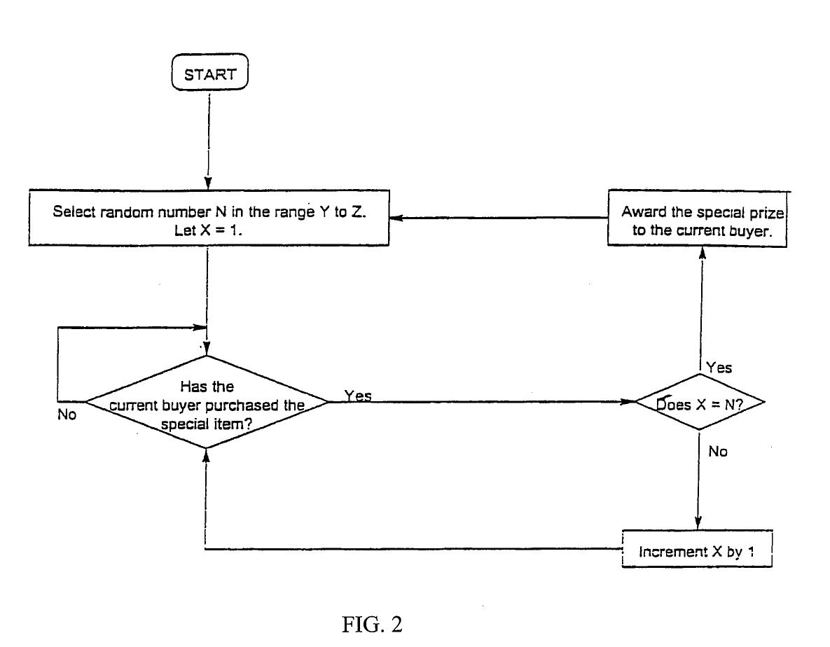

### DETAILED DESCRIPTION OF THE INVENTION

In the drawing, reference numeral 10 generally designates a customer reward system in accordance with the invention. The system comprises a plurality of activity monitoring mean 12. Each activity monitoring means is connected to a processing-means or microprocessor 14. The microprocessor 14 includes a comparator 16. A display means in the form of a meter 18 is connected to the microprocessor 14.

In one embodiment of the invention, each activity monitoring means is in the form of a point of sales device such as a cash register. In this embodiment, the system 10 is intended for use where goods or merchandise are sold. The intention is that, upon the occurrence of a particular trigger condition when a customer purchases the relevant goods, a reward is given to that customer. The reward could be a monetary prize, free merchandise, overseas holidays, or the like.

In particular each time a customer pays for merchandise via one of the cash registers 12 at a venue, this is detected by the microprocessor 14. The microprocessor 14 establishes the trigger condition via a random number generator. The random number generator generates a random number which, if desired, may be displayed on the display 18. Then, each time a transaction occurs at one of the cash registers 12 connected to the microprocessor 14, the number of that transaction is compared with the random number generated by means of the comparator 16 of the microprocessor 14. If the number of the transaction coincides with the random number, the prize is awarded to the customer who caused that transaction number to occur.

In other forms of this embodiment, instead of transaction numbers causing the trigger condition, the trigger condition could be based upon the sale of a predetermined quantity of a particular type of merchandise. For example, if the tenth sale of that type of merchandise occurs in a day and ten happens to be the trigger condition, the prize will be awarded upon such tenth sale.

In still other variations of this embodiment, the trigger condition could be based on monetary amounts or a number of points.

In all the embodiments, the trigger condition is only activated after the occurrence of an initiating condition. This initiating condition is a minimum amount of trading activity which is calculated based on the number of articles sold, a predetermined monetary amount or a number of points. In other words, the initiating condition sets a minimum number of a set of numbers in which the number constituting the trigger condition falls.

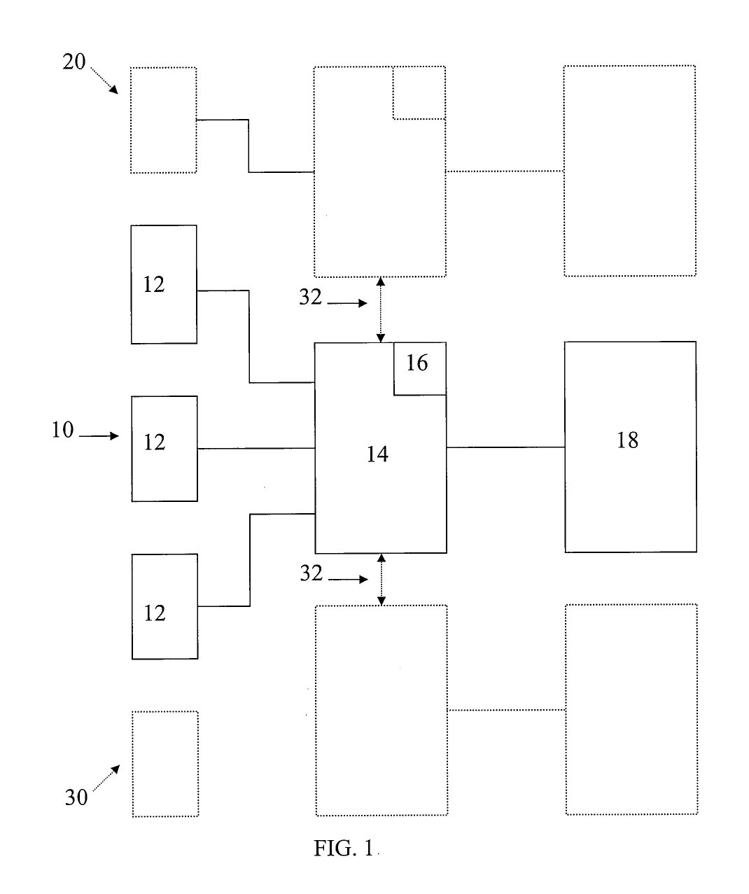

As illustrated in FIG. 1 of the drawings, various systems 10 could, if desired, be networked together. This is shown by systems 20 and 30 in dotted lines with the networking being illustrated schematically at 32.

The networked arrangement of systems would be applicable where, for example, the trading activity takes place at a large number of related venues, for example, a chain of fast food outlets. Then, if the trigger condition is met at any one of the venues, the prize, while being awarded at that venue, will be displayed on the meters 18 at each of the venues.

In another embodiment of the invention, the system 10 is used in the racing industry where each time a bet is placed a prize level increases by a predetermined amount. When this predetermined amount coincides with the trigger condition, a prize is paid. Various categories could be used for payment of prizes. Thus, for example, a prize could be awarded in respect of each race, each meeting, each week or each month. Once again, if desired, the system 10 for use in the racing industry could be networked with other similar systems 20 and 30.

Thus, it is an advantage of the invention, that a system 10 is provided which rewards existing customers, encourages increased purchases by those customers and which will attract new customers.

It will be appreciated by persons skilled in the art that numerous variations and/or modifications may be made to the invention as shown in the specific embodiments without departing from the spirit or scope of the invention as broadly described. The present embodiments are therefore, to be considered in all respects as illustrative and not restrictive.

1. A customer reward system, comprising
an activity monitor to monitor each customer transaction of a plurality of transactions, and to supply data indicative of each customer transaction;
a processor to receive data from said activity monitor that is indicative of each customer transaction, and to generate an output signal indicative of a reward granted to a customer in response to (a) determining that the plurality of customer transaction collectively satisfy an initiating condition associated with the reward, and (b) determining that a customer transaction of the customer satisfies a trigger condition associated with the reward; and
a display to display data of each customer transaction, the initiating condition, and the trigger condition.

2. The system of claim 1, wherein the processor is configured to determine that the trigger condition is satisfied when a number associated with the customer transaction of the customer coincides with a random number associated with the reward.

3. The system of claim 2, wherein the number associated with the customer transaction of the customer relates to a monetary amount of the customer transaction.

4. The system of claim 2, wherein the number associated with the customer transaction of the customer relates to a quantity of goods vended by the transaction.

5. The system of claim 1, wherein the activity monitor is one of a plurality of activity monitors connected to the processor so that customer transactions monitored by any one of the activity monitors affects generation of the output signal.

6. The system of claim 5, wherein activity monitors of the plurality of activity monitors are remote from each other and are networked with one another.
